(19) United States
(12) Patent Application Publication
(10) Pub. No.: US 2007/0007141 A1
(43) Pub. Date: Jan. 11, 2007

(54) Method for manufacturing a fuel-cell stack and terminal plate

(76) Inventors: Masashi Maeda, Kariya-shi (JP); Masanori Matsukawa, Oubu-shi (JP); Tsunemasa Nishida, Toyota-shi (JP); Chisato Kato, Aichi-ken (JP); Naohiro Takeshita, Susono-shi (JP)

Correspondence Address: YOUNG & THOMPSON, 745 SOUTH 23RD STREET, 2ND FLOOR, ARLINGTON, VA, 22202, US

(21) Appl. No.: 11/475,094

(22) Filed: Jun. 27, 2006

(30) Foreign Application Priority Data
Jun. 29, 2005 (JP) 2005-189164
Apr. 25, 2006 (JP) 2006-120388

(51) Int. Cl. H01M 4/02

(52) U.S. Cl. 205/57

(57) ABSTRACT

A fuel-cell stack is provided wherein an insulating resin layer having good electrical insulation characteristics is inserted between a terminal and end plate, so that an insulating plate is discarded so as to make the same more lightweight and downsized. It comprises a battery-cell group wherein a plurality of battery cells and separators are arranged; and terminal plates 1 and end plates 3 that are arranged on each end portion of the battery-cell group. The end plates 3 are formed as metal plate members having surfaces 31 opposing to the terminal plates 1. A polyimide film 35 is formed as an insulating resin layer at least on the opposing surface 31 of the end plate 3 for electrically insulating between the end plate 3 and terminal plate 1 by an electro-deposition coating method.

### FIELD OF THE INVENTION

The present invention relates to a fuel-cell stack, particularly to improvements in construction of an electrical insulation between a terminal plate and an end plate that are located on both ends of the fuel-cell stack. The present invention also relates to a method for manufacturing a terminal plate that comprises such electrical insulation construction.

### BACKGROUND OF THE INVENTION

As shown in FIG. 4, a conventional fuel-cell stack comprises: a battery cell group C, in which a plurality of battery cells and separators are alternately arranged and connected in series; and end-plate groups, which are located on both ends of the battery-cell group C and are each made up of terminal plate 1, insulation plate 2 and end plate 3; and the fuel-cell stack is constructed so that these groups are connected by a connection member 4 (for example, refer to patent document 1). The end plates 3 serve the purpose of directly receiving the tightening force of the connection member 4, and applying a specified surface pressure to the battery-cell group C. The insulation plates 2 are plate-shaped insulation members for electrically insulating between the terminal plate 1 as electrode terminal, and the end plate 3.

On the other hand, in order to reduce the weight of the fuel-cell stack, a method has been proposed (for example, refer to paragraph [0003] of patent document 2) in which the insulation plates are eliminated from the end-plate groups, and in their place, the inner surfaces of the end plates (surfaces facing the terminal plates) are coated with insulating resin by an evaporation method that is sprayed resin on the surfaces. However, the above evaporation method had problems in that it was subject to occurrence of insulation defects due to pin holes that were caused by resin particles, air bubbles and the like, and another problems in that adherence defects, such as easy detachment of the evaporation-coated resin due to its fragility, occurred on the edges and corners of the generally rectangular-shaped end plates (refer to paragraph [0018] of patent document 2).

In order to avoid the drawbacks of this kind of insulation coating formed by the evaporation method, in the fuel cell of patent document 2, an approximately 200 μm thick film sheet structure made from a fluororesin (insulating resin) is formed into a box shape that surrounds from the bottom plate section up around the four side plate sections to a specified height with the top surface open, and the film sheet structure of that box with open top is fitted over the surface of one side of the end plate body (a metal plate having sufficient strength) to form an end plate (refer to paragraphs [0016] and [0017] of patent document 2).

[Patent Document 1]

Japanese Patent Kokai Publication No. JP-P2003-346869A

[Patent Document 2]

Japanese Patent Kokai Publication No. JP-A-10-270066

[Patent Document 3]

Japanese Patent Kokai Publication No. JP-P2003-249240A (separator)

[Patent Document 4]

Japanese Patent Kokai Publication No. JP-P2004-31166A (Electro-static paint for a metallic separator)

However, drawbacks are also found in the end plates having the insulating film sheet structure of patent document 2. In other words, the existence of pin holes can be made nearly zero by maintaining a film sheet thickness of approximately 200 μm, but it is necessary to form the film sheet, having that film thickness, separately from the end-plate body. Therefore, in the case where the end plate itself is formed into a complex shape such as by giving the end plate body a minute concavo-convex shape, there is a problem in that it is difficult to form a film sheet structure beforehand having a corresponding shape. In a fuel cell, there is a tendency for the shape of the end plate to become complex corresponding with the multi-functionality of the plate material, and it is not easy to apply the art of patent document 2 to the end plate having a complex shape. Moreover, as in the case of the aforementioned evaporation method, the art of patent document 2 as well does not present an essential solution to the problem of poor adherence of the film coating on the edges and corners of the end plate body.

Also, in the case of the insulating film of patent document 2, the thickness is approximately 200 μm, therefore it is considered to be difficult to keep fluctuations in the film thickness to a minimum, for example 10 μm or less, Furthermore, in order to reduce fluctuation in the film thickness, even when performing coating with an insulating film having a thin thickness, such as 50 μm, not only is it difficult to manufacture such a thin insulating film, but it is also considered to be very difficult to uniformly coat the end plate. Particularly, even when coating an end plate having a complex concavo-convex shape with an insulating film having a thickness of 50 μm or less, fluctuation occurs in the adherence between the insulating film and end plate. Due to this, areas apt to start damage are formed in the insulating film so that the damage such as cracking occurs. Accordingly, there is a problem in that the insulating capability of the insulating film cannot work fully.

### SUMMARY OF THE DISCLOSURE

This invention has been achieved in consideration of the aforementioned problems. Patent document 3 and patent document 4 disclose techniques for coating the surface of the separators of the battery-cell group of the fuel-cell stack using an electro-deposition coating method, however, the object of these techniques relates to an electrical conductive coating for the purpose of improving resistance to corrosion due to corrosive gas (corrosion protection).

It is an object of the present invention is to provide a fuel-cell stack that uses an insulating resin layer having good electrically insulating properties between the terminal plates and end plates so that insulating plates can be discarded and thus the fuel-cell stack can be made more lightweight and downsized. Moreover, it is another object of the present invention to provide a fuel-cell stack that enables to form insulating resin layers even when the end plates or terminal plates has a complicated shape. It is a further object of the present invention to provide a method for manufacturing the terminal plates for a fuel-cell stack that comprises the aforementioned electrically insulating construction.

According to the present invention, it is intended to form an insulating resin layer having good electrically insulating properties between a terminal plate and end plate. As a result of studying the cause of defects that occur when forming film by an evaporation method (pin holes, poor adherence), it was found that film formed by an electro-deposition method from among film formation methods displayed good uniformity and continuity over a plate substrate, and had high electrically insulating performance even for relatively thin film.

According to a first aspect (claim 1) of the present invention, there is provided a fuel-cell stack that comprises a battery-cell group in which a plurality of battery cells and separators are arranged; and terminal plates and end plates that are arranged on each end section of the battery-cell group. Also, an end plate of the fuel-cell stack is formed as a metal plate having a surface opposing to a terminal plate, and an insulating resin layer that electrically insulates between the end plate and terminal plate is formed by an electro-deposition coating method on at least the opposing surface of the end plate (aspects 1, 2, 6 to 11).

Alternatively, a terminal plate of the fuel-cell stack is formed as a conductive metal plate having a surface opposing to an end plate, and an insulating resin layer for electrically insulating between the terminal plate and end plate is formed by an electro-deposition coating method on at least the opposing surface of the terminal plate (aspects 3 to 11). Further, aspects of the present invention are disclosed in the dependent claims.

More preferably, in the fuel-cell stack of the present invention, curved surfaces are formed on the edge portions, which are formed by the opposing surface of the end plate (or terminal plate) and at least one non-parallel surface that intersects the opposing surface, so that the curved surface smoothly connects the opposing surface with the non-parallel surface(s); and the insulating resin layer continuously covers over the opposing surface, curved surface(s) and non-parallel surface(s) of the end plate (or terminal plate) (aspects 2 and 4).

The method for manufacturing a terminal plate for a fuel-cell stack of this invention (aspect 14) is a method for manufacturing a terminal plate for a fuel-cell stack whose surface is covered with an insulating resin layer made of a polyimide film and a conductive layer comprising the steps of:

a preparation step of preparing an electrically conductive metal plate member having a surface opposing to an end plate;

an electro-deposition coating step of forming an insulating resin film on at least said opposing surface of the entire surface of said electrically conductive metal plate member by an electro-deposition coating method using an electro-deposition coating material of an insulating resin; and

a plating step of coating the portions that are not coated by said insulating resin film with a conductive layer made from an electrically conductive metal by plating using said insulating resin film as a masking material during plating.

Further aspects of the method of the present invention are disclosed in the corresponding dependent claims.

Further preferably, in the method for manufacturing a terminal plate for a fuel-cell stack, the electrically conductive layer formed by the plating step includes an anti-corrosive electrically conductive layer made from anti-corrosive electrically conductive metal superior in resistance to corrosion to the electrically conductive metal of the plate member.

Each of the component elements of the present invention and further preferable embodiments and additional component elements of the present invention are explained in PREFERRED EMBODIMENTS, mentioned hereinafter.

The meritorious effects of the present invention are summarized as follows.

According to the fuel-cell stack of the present invention (aspects 1 and 3), the insulating resin layer that is formed on the end plates or terminal plates by an electro-deposition coating method displays good electrically insulating properties even for a relatively thin film so that insulating plates can be discarded and thus the fuel-cell stack can be made lightweight and downsized. Particularly, the insulating resin layer formed by an electro-deposition method displays excellent adhesion and shape adaptability to the plate substrate, and has uniform film thickness and continuity. Hence, the insulating resin layer hardly suffers from damages such as peeling of the film, pin holes, cracking of the film and the like even when the surface of the substrate has a complex concavo-convex shape, and enables stable maintaining of the electrically insulating performance.

Moreover, when curved surfaces are formed on the edge (or corner) portions of the end plates or terminal plates that are formed by the opposing surface and the non-parallel surfaces intersecting with the opposing surface in a way that an insulating resin layer is continuously formed over the opposing surface, curved surface(s) and non-parallel surface(s) of the plate, edges (corners), which may start damages due to the concentration of internal stress (residual stress) of that insulating resin layer, do not exist, so that local cracking and damages in the insulating resin layer can be avoided. Consequently, adhesion and continuity of the overall insulating resin layer is improved, and electrically insulating properties become more stable.

According to the method for manufacturing a terminal plate for a fuel-cell stack of the present invention (aspect 9), by forming a polyimide film as an insulating resin layer, and an electrically conductive layer on the surface of an electrically conductive metal plate member, it is possible to efficiently manufacture a terminal plate also having the function of the prior insulating plate. Particularly, since the polyimide film as an insulating resin layer, which is formed by electro-deposition coating, can be used as masking material during plating of the electrically conductive layer, the manufacturing step is simplified and thus the manufacturing cost can be reduced.

Further, when the electrically conductive film formed in the plating step includes an anti-corrosive electrically conductive layer made from anti-corrosive electrically conductive metal superior in resistance to corrosion to the electrically conductive metal of the plate member, even a plate member made from a widely used electrically conductive metal having a generally low resistance to corrosion can be freely used, and thus the manufacturing cost can be reduced.

### BRIEF DESCRIPTION OF THE DRAWINGS

FIG. 1 is a front view of an embodiment of a fuel-cell stack of the present invention.

FIG. 2 shows an embodiment of an end plate, and is a horizontal sectional view and an enlarged view of the section indicated by the dotted line of the terminal plate and end plate (separated state) at the position of the horizontal section shown in FIG. 1.

FIG. 3 shows an embodiment of a terminal plate, and is a horizontal sectional view and an enlarged view of the section indicated by the dotted line of the terminal plate and end plate (separated state) at the position of the horizontal section shown in FIG. 1.

FIG. 4 is a front view of a conventional fuel-cell stack.

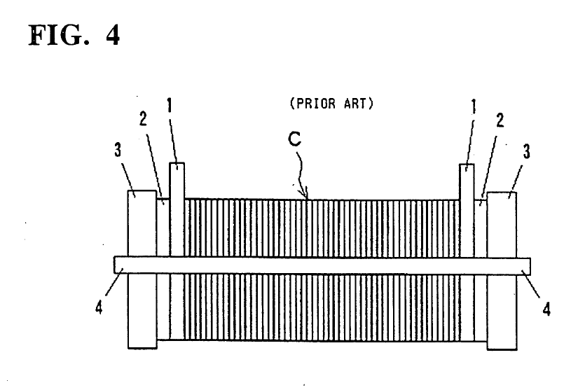

### PREFERRED EMBODIMENTS

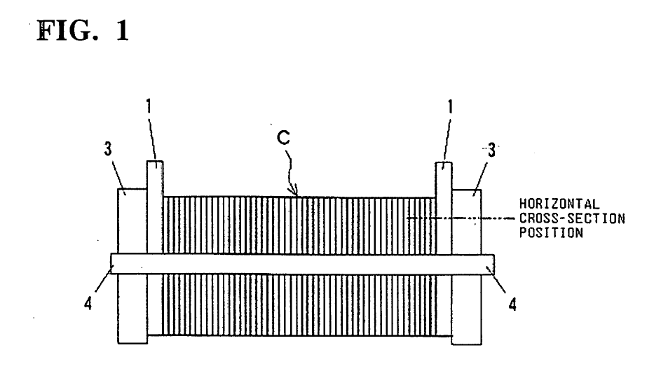

As shown in FIG. 1, a fuel-cell stack of the present invention comprises a battery-cell group C that is made up of a plurality of arranged battery cells and separators; terminal plate 1 and end plate 3 that are arranged on each of the end sections of the battery-cell group C; and a connection member 4 that binds and connects these (C, 1, 3) together.

The end plates 3 are made of material having high strength and high rigidity so as to directly receive the tightening force from the connection member 4. Iron-based material such as stainless steel, cast steel, cast iron and the like or magnesium material can be used as a material for the end plates 3. Generally, the end plates 3 are formed into a relatively thick plate shape (that is, a relatively planar rectangular shape) in order to maintain the high rigidity on their own.

The terminal plates 1 are located on both ends of the battery-cell group C and function as electrode terminals, so are made from electrically conductive material. Considering the economic advantage and general-purpose properties, an electrically conductive metal is preferred to be used as the conductive material of the terminal plates 1. Aluminum material (aluminum and its alloys), copper, silver and the like can be used for the electrically conductive metal of the terminal plates 1. In general, the terminal plates 1 are formed into a relatively thin plate shape.

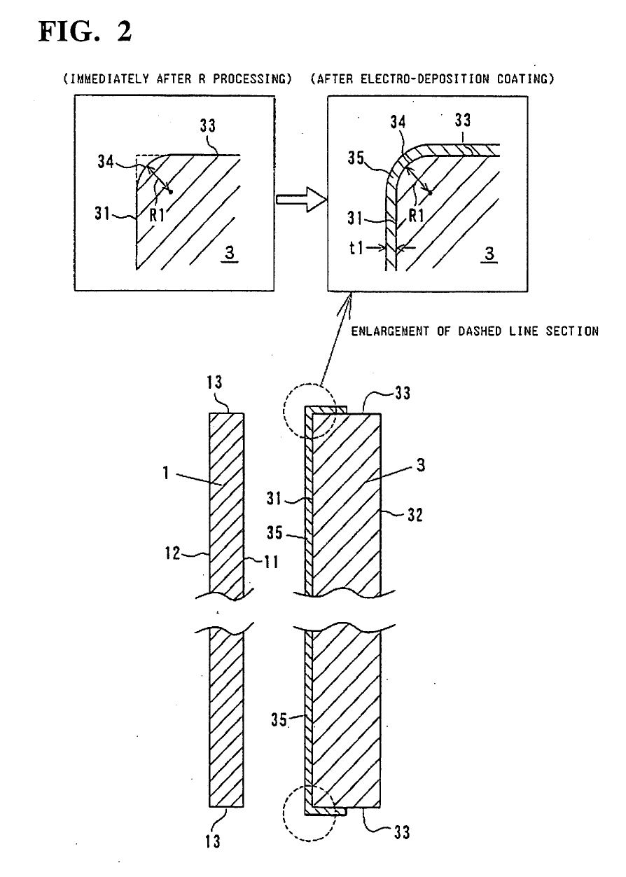

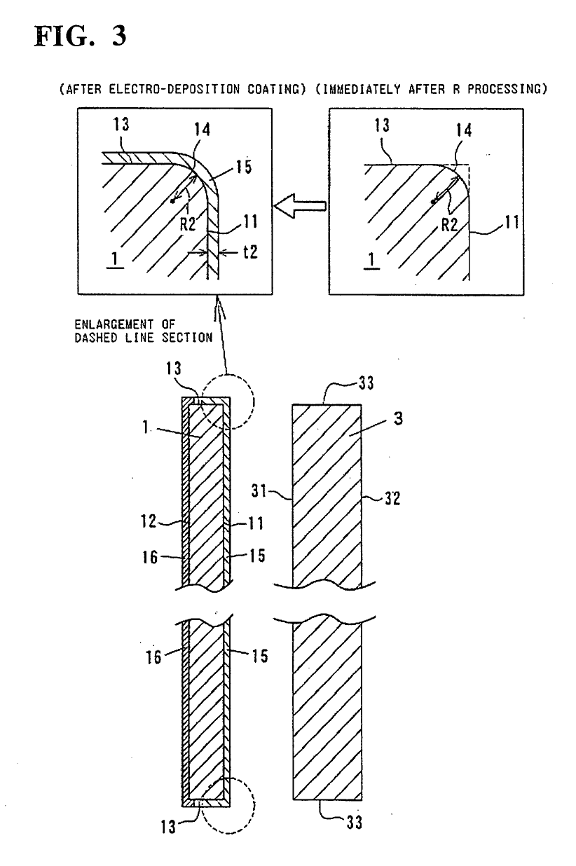

FIG. 2 and FIG. 3 show a horizontal cross-sectional view of a terminal plate 1 and end plate 3 at the position of the horizontal section shown in FIG. 1 (in order to make it easier to view the state of the film on top of the plates, both of the plates 1, 3 are shown in a separated state). As shown in FIG. 2 and FIG. 3, the end plate 3 has at least an opposing surface 31 that faces and comes in contact with the terminal plate 1, and non-parallel surfaces that intersect with the opposing surface 31 (for example the peripheral surface 33 that crosses at a right angle), and at the boundary between the opposing surface 31 and the non-parallel surfaces 33, the existence of edge (or corner) portions formed by these surfaces is expected. Similarly, the terminal plate 1 has at least an opposing surface 11 that faces and comes in contact with the end plate 3, and non-parallel surfaces that intersect with the opposing surface 11 (for example the peripheral surface 13 that crosses at a right angle), and at the boundary between the opposing surface 11 and the non-parallel surfaces 13, the existence of edge portions that are formed by these surfaces is expected.

In the fuel-cell stack of the present invention, an insulating resin layer (35 or 15) as a coating is formed by an electro-deposition coating method on either surface of the opposing surface 31 of the end plate 3 or the opposing surface 11 of the terminal plate 1. This insulating resin layer (35 or 15) is interposed between the end plate 3 and terminal plate 1 in a state after the fuel-cell stack has been completely assembled, and then electrically insulates the end plate 3 from the terminal plate 1, functioning as an electrically insulating layer in the place of the insulating plate conventionally required. Therefore, by discarding the insulating plate, the fuel-cell stack can be made lighter and more compact. Further, since an electro-deposition coating method is employed as a method for forming the insulating resin layer (35 or 15), it is possible to coat the surface to be coated uniformly in all directions. The film formed by electro-deposition coating is very high in uniformity, and any pin holes and the like rarely occur so that insulation defects caused by pin holes and the like hardly come up.

When the coated object (the end plate 3 or terminal plate 1) is made of metal, it is preferred that cathodic electro-deposition coating, in which a negative voltage is applied to the to-be coated object and the electro-deposition material positively polarized is deposited on the surface of the to-be coated object, be employed as the method for electro-deposition coating of the end plate 3 or terminal plate 1.

The electro-deposition coating material used in electro-deposition coating is not particularly limited, however, it is preferred that at least one selected from the group of polyimide electro-deposition material, fluororesin electro-deposition material, polyamide-imide electro-deposition material, epoxy resin electro-deposition material, or acrylic resin electro-deposition material and a copolymer thereof be used. Most preferably, cation type polyimide electro-deposition material, which contains polyimide of a chemical structure as shown by the following chemical formula 1 as the main component, is used as the polyimide type electro-deposition material. In the chemical formula 1, R represents an alkyl group (chain), and Ar represents aromatic group (structure). The dielectric breakdown voltage of this cation-type polyimide electro-deposition material is approximately 1000V, and has extremely high insulating characteristics. Also, the glass-transition temperature of this cationic polyimide electro-deposition material is approximately 200° C. (DSC measurement), the 5% mass reduction temperature is approximately 400° C. (TGA measurement), and has a very high thermal resistance as an organic polymer. Generally, it is preferred that the electro-deposition coating material has a glass-transition temperature of approximately 200° C. or higher. Also it is preferred that the breakdown voltage of the electro-deposition coating film amounts to at least approximately 1000° C.

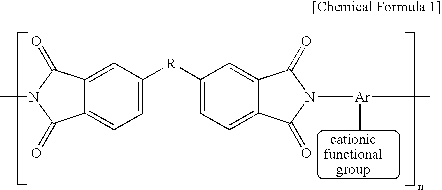

After performing cationic electro-deposition coating of the end plate 3 or terminal plate 1 using a cation-type polyimide electro-deposition coating material, it is preferred to fix (cure) the polyimide electro-deposition coating material to the coated object by heat fixation (curing) (for example, baking). Particularly, when the coated object is the terminal plate 1, an electrically conductive surface or conductive section on a part of the terminal plate 1 needs to secured, accordingly it is preferred that electro-deposition coating be performed after masking the electrically conductive surface of the terminal plate 1 as necessary. The electro-deposition coating conditions, the pre-processing and post-processing methods for the coated object, and the heat-fixation conditions of the electro-deposition coating material and the like are suitably selected according to the type and properties of the electro-deposition material used.

By forming an insulating resin layer (35 or 15) by electro-deposition coating, fluctuation in the thickness (t1 or t2) of the insulating resin layer (35 or 15) can be reduced. For the insulating resin layer that is formed on the opposing surface 31 of the end plate 3 (except for the edge (or corner) portions (including the curved surface(s) 34) and peripheral side surface(s) 33 of the end plate 3) or on the opposing surface 11 of the terminal plate 1 (except for the edge (or corner) portions (including the curved surface(s) 14) and peripheral side surfaces 13 of the terminal plate 1), the standard deviation σ of the film thickness calculated from at least 10 arbitrary locations is desired to be 1 μm or less. By making the film thickness uniform, it is possible to prevent damage to the insulating resin layer.

Hereupon, when the film thickness at n locations (n≧10) of the insulating resin layer (35 or 15) on the opposing surface (31 or 11) is taken as x1, x2, . . . , xn, the standard deviation σ is calculated from the following Equation 1.

$$σ = \sqrt{\frac{n {\sum }_{i = 1}^{n} {x}_{i}^{2} - {( {\sum }_{i = 1}^{n} {x}_{i} )}^{2}}{{n}^{2}}} \qquad [ Equation 1 ]$$

The thickness (t1 or t2) of the insulating resin layer (35 or 15), for example the average film thickness, is suitably set according to the electric power output by way of the terminal plate 1, or the strength and insulating properties of the insulating resin layer. In many cases, the thickness of the insulating resin layer is preferred to be set 10 μm to 40 μm, particularly 20 μm or greater in general. When the film thickness of the insulating resin layer (35 or 15) is less than 10 μm, there is a concern that the insulating properties of the insulating resin layer (35 or 15) may be insufficient. In order to maintain the insulating properties of the insulating resin layer (35 or 15), a film thickness of at least 40 μm is considered to be sufficient.

In the present invention, as in the case of calculating the standard deviation, the average film thickness of the insulating resin layer (35 or 15) is the arithmetic average of the film thickness measured at least at 10 arbitrary locations.

When the average film thickness of the insulating resin layer (35 or 15) is 10 μm to 40 μm, it is preferred the coefficient of variance CV calculated from the standard deviation σ to be 0.05 or less. The coefficient of variance CV is the ratio between the standard deviation and the arithmetic average, and is calculated from the following Equation 2.

$$CV = \frac{σ \cdot n}{{\sum }_{i = 1}^{n} {x}_{i}} \qquad [ Equation 2 ]$$

It is preferred that the adherence between the insulating resin layer and the coated object satisfy classification 0 (see Table 1) regulated in JIS 5600-5-6 when evaluating the test results by a testing method compliant with JIS 5600-5-6.

Prior to coating at least the opposing surface (31 or 11) of the end plate 3 or terminal plate 1 with an insulating resin layer (35 or 15) using an electro-deposition coating method, it is preferred that R processing of the edge (or corner) be performed as pre-processing to the end plate 3 or terminal plate 1 that comes to be the base material. ‘R processing’ referred to here is the rounding step of forming smooth curved surface(s) (34 or 14) connecting the opposing surface and non-parallel surface(s) at the edge (or corner) portions that are formed by the opposing surface (31 or 11) of the plate (3 or 1) that serves as the base material and the non-parallel surface (33 or 13) that intersects with the opposing surface 11. Specific examples of methods for performing this R processing include mechanical processing such as chamfering or grinding, or chemical processing. An example of chemical R processing is a processing method to make the edges of the edge portions rounded by immersing the plate for a specific period of time in an etching solution that is capable of dissolving the plate material. By performing such R processing beforehand, it enables to continuously coat without any problems over the opposing surface (31 or 11) of the plate (3 or 1) being the base material, curved surfaces (34 or 14) and non-parallel surfaces (33 or 13) with an insulating resin layer (35 or 15), and thus improve the adhesion and continuity of whole the insulating resin layer toward the plate to be the base material, and stabilize the electrically insulating characteristics furthermore.

In the examples shown in FIG. 2 and FIG. 3, the insulating resin layer (35 or 15) that is coated on part of the peripheral side surfaces 33 as the non-parallel surface(s) that intersects with the opposing surface 31 of the end plate 3 at right angles, or part of the peripheral side surface 13 as the non-parallel surface that intersects with the opposing surface 11 of the terminal plate 1 at right angles, covers from the edges (four sides) of the opposing surface of the plate to the top of the peripheral surfaces. Therefore, even when dust or foreign matter comes in contact with the peripheral surfaces of the plate, it is possible to prevent from shorting out between the both plates 1 and 3 which may be caused by such dust or foreign matter served as an electrical bridge.

As shown in FIG. 3, the remaining portions of the terminal plate 1 other than covered with the insulating resin layer 15 is preferred to be covered with an electrically conductive layer 16 made from an electrically conductive metal. The electrically conductive metal of the conductive layer 16 can be gold (Au), silver (Ag), platinum (Pt), palladium (Pd), tin (Sn), zinc (Zn), copper (Cu), nickel (Ni) or the like. Among them, particularly gold (Au), silver (Ag) and platinum (Pt) are metals that have good resistance to corrosion (anti-corrosive conductive metals). It is extremely preferred for the conductive layer 16 to include an anti-corrosive conductive layer made from an anti-corrosive conductive metal that has better resistance to corrosion than the conductive metal of the plate material of the terminal plate 1. “To Include the anti-corrosive conductive layer” is referred to here mean not only that the conductive layer 16 has, for example, multilayer construction, and one of those layers is anti-corrosive conductive, but also that the conductive layer 16 itself is an anti-corrosive conductive layer.

Among the entire surface of the terminal plate 1, the surface on the side that comes in contact with the battery-cell group C is not necessarily required anti-corrosive properties. However, when the surface of the terminal plate 1 is covered with an insulating resin layer 15 and a conductive layer 16 having an anti-corrosive conductive layer, the resistance to corrosion on the surface of the terminal plate 1 is definitely improved. In that case, an electrically conductive metal of low resistance to corrosion such as aluminum or copper that is relatively inexpensive as the conductive material of the terminal plate 1 can be employed so that the manufacturing cost of the terminal plate 1 can be reduced.

The following procedure is favorable as the method for manufacturing the terminal plates 1 for the fuel-cell shown in FIG. 3.

First, a conductive metal plate member (1) that has an opposing surface 11 that faces the end plate 3 is prepared (preparation step). Immediately after this preparation step, it is preferred that R processing be performed on the edge portions, which are formed by the opposing surface 11 of the conductive metal plate member (1) and the non-parallel surfaces (for example, peripheral side surfaces 13) that intersects with the opposing surface 11, in order to form curved surfaces 14 that smoothly connect the opposing surface 11 with the non-parallel surfaces 13 (R processing step). The preferred processing of the R step is as previously explained.

Next, an insulating resin film (preferably a polyimide film) 15 is coated on at least the opposing surface 11 of the surfaces of the conductive metal plate member by an electro-deposition coating method using a (polyimide) electro-deposition coating material (electro-deposition coating step). More specifically, masking is performed beforehand for the conductive surfaces of the terminal plate 1 or areas that must be exposed as conductive areas, and then after the masking is complete, electro-deposition coating is performed for the conductive method plate member (1) using the electro-deposition coating material. The preferred step of the electro-deposition coating material and electro-deposition-coating method are as previously explained. After the resin film 15 has been formed on the plate member, the masking material is removed, and then as necessary, the resin film 15 is fixed (cured) to the plate member by heat fixation (curing) or the like. It is preferred that the resin film 15 be coated on the conductive metal plate member (1) treated with the R processing by an electro-deposition coating method using the resin electro-deposition coating material so that the opposing surface 11, curved surfaces 14 and non-parallel surfaces 13 are coated continuously.

Finally, the areas on the surface of the conductive metal plate member (1) that are not covered by the resin film 15 are covered by a conductive layer 16 made from a conductive metal using a plating step that uses the resin film 15 as masking material during plating (plating step). Particularly, it is preferred that a conductive layer 16 be formed to contain an anti-corrosive conductive layer made from an anti-corrosive conductive metal having stronger resistance to corrosion than the conductive metal of the plate member of the terminal plate 1. For example, it is extremely preferred that gold (Au) be used as the (anti-corrosive) conductive metal for plating. In this plating step, it is possible to simply perform non-electrolytic plating by immersing the conductive metal plate member (1) with a resin (polyimide) film 15 into a metal compound plating bath. During this step, the resin (polyimide) film 15 acts as a masking material in the metal compound plating bath for the non-electrolytic plating step, so the metal film does not adhere to the surface of the resin (polyimide) film 15.

The terminal plate 1 for a fuel-cell stack is thus manufactured by the preparation step, electro-deposition coating step and plating step so that the surface is covered with a resin (polyimide) film 15 as an insulating resin layer, and with a conductive layer 16. With this manufacturing method, the resin (polyimide) film 15 that is formed as an insulating resin layer in the electro-deposition coating step can be used as is as the masking material when performing the plating step of the conductive layer 16, so it is possible to simplify the manufacturing step and reduce the manufacturing cost.

Detailed examples of the end plates 3 and terminal plates 1 of the invention are explained as below.

### EXAMPLE 1

### Example of an End Plate

A stainless steel (SUS316) plate member was prepared as an end plate 3. This stainless steel plate member was formed into a relatively flat rectangular shape having the dimensions, 300 mm (height)×200 mm (width)×20 mm (thickness) approximately. As shown in FIG. 2, this rectangular-shaped end plate 3 has an opposing surface 31 (inner surface) facing to a terminal plate 1, and an opposite surface 32 (outer surface) on the opposite side of the opposing surface 31, and four peripheral side surfaces 33 that define four sides of these two surfaces. Each of the four peripheral surfaces 33 intersects with the opposing surface 31 and opposite surface 32 at right angles.

First, R processing was performed for the edge-shaped edge (or corner) portions that are formed by the opposing surface 31 of this rectangular-shaped end plate, and each of the peripheral surfaces 33 that intersects with the opposing surface at right angles. R processing was accomplished by immersing the end plate into an etching solution that is capable of dissolving stainless steel (for example, mixed aqueous solution of phosphoric acid, nitric acid, hydrochloric acid and acetic acid) for a specified period of time. Through this R processing, the edge portions were changed from a sharp edge shape to a curved shape with no sharp edge, and curved surfaces 34 appeared on the edge (or corner) portions. The radius of curvature R1 of the curved surface 34 was approximately 0.2 to 0.5 mm.

Next, the opposite surface 32 of the end plate, and part of the four peripheral side surfaces 33 connecting to (transmitting) the four peripheral sides of the opposite surface 32 were masked with a masking material (for example, an insulating masking tape commercially available), and the opposing surface 31 of the end plate and the remaining portions of the four peripheral side surfaces 33 connecting to the four sides of the opposing surface 31 were left exposed. The end plate 3 with the masking material was sufficiently cleaned and degreased, and then rinsed in ion-exchange water or purified water. Meanwhile, cation-type polyimide electro-deposition coating material (Elecoat PI, Shimizu, Co., Ltd.) was diluted with ion-exchange water to a suitable concentration to prepare a water bath in an electro-deposition coating tank, and the bath temperature was adjusted to approximately 25° C. The cleaned end plate 3 was immersed in that polyimide electro-deposition coating bath, and part of the end plate 3 (electrode-connection part) was connected to a negative terminal of a direct-current power supply apparatus, with a carbon (opposing) counter-electrode immersed in the water bath being connected to the positive terminal thereof, and a voltage of 20 to 220 V was applied for approximately 2 minutes, to perform electro-deposition coating. After that, the end plate 3 was removed from the electro-deposition coating tank and rinsed with water, and then pre-dried (for approximately 10 minutes at 80 to 100° C.) after air blowing. The masking material was removed from the pre-dried end plate 3, and subsequently the end plate 3 was moved to a heating apparatus, where the polyimide electro-deposition coating was baked (for 30 minutes at approximately 210° C.).

As shown in FIG. 2, a stainless steel end plate 3 was obtained on which a polyimide film 35 was formed on the opposing surface 31 of the end plate and part of the four peripheral surfaces 33 connecting to the four sides of that opposing surface 31 as an insulating resin layer. The film thickness t1 was measured at 14 locations of the polyimide film 35 that was formed on the opposing surface 31 of the end plate 3 (except for the curved surface 34). The average film thickness of the polyimide film 35, as well as the standard deviation and coefficient of variance were calculated from the 14 values of film thickness, and the each calculated value was 22.94 μm for the average film thickness, 0.59 μm for the standard deviation, and 0.026 for the coefficient of variance. A fuel-cell stack as shown in FIG. 1 was constructed with an end plate 3 of which at least the opposing surface 31 was covered by a polyimide film 35, and found that there were no problems with the electrically insulating characteristics between the terminal plate 1 and end plate 3.

### EXAMPLE 2

### Example of a Terminal Plate

An aluminum alloy plate member was prepared as a terminal plate 1. This aluminum alloy plate member was formed into a relatively flat rectangular shape having the dimensions, 300 mm (height)×200 mm (width)×2 mm (thickness), approximately. As shown in FIG. 3, this rectangular-shaped terminal plate has an opposing surface 11 (outer surface) that faces the end plate 3 and an opposite surface 12 on the opposite side (inner surface) of the opposing surface 11, and four peripheral side surfaces 13 that define the four sides of these two surfaces. Each of the four peripheral surfaces 13 intersects with the opposing surface 11 and opposite surface 12 with at right angles.

First, R processing was performed for the edge-shaped edge portions that are formed by the opposing surface 11 of this plate-shaped terminal plate, and each of the peripheral surfaces 13 that intersects with the terminal plate at right angles. R processing was accomplished by immersing the terminal plate into an etching solution that is capable of dissolving aluminum alloy (for example, mixed aqueous solution of phosphoric acid, nitric acid, sulfuric acid and acetic acid) for a specified period of time. Through this R processing, the edge portions were changed from a sharp edge shape to a curved shape with no sharp edge, and curved surfaces 14 appeared on the edge portions. The radius of curvature R2 of the curved surface 34 was approximately 0.2 to 0.5 mm.

Next, the opposite surface 12 of the terminal plate, and part of the four peripheral side surfaces 13 connecting (transmitting) to the four peripheral sides of the opposite surface 12 were masked with a masking material (for example, an insulating masking tape commercially available), and the opposing surface 11 of the terminal plate and the remaining portions of the four peripheral side surfaces 13 connecting to the four sides of the opposing surface 11 were left exposed. The terminal plate 1 with the masking material was sufficiently cleaned and degreased, and then rinsed in ion-exchange water or purified water. Meanwhile, cationic polyimide electro-deposition coating material (Elecoat PI, Shimizu, Co., Ltd.) was diluted with ion-exchange water to a suitable concentration to prepare a water bath in an electro-deposition coating tank, and the bath temperature was adjusted to approximately 25° C. The cleaned terminal plate 1 was immersed in that polyimide electro-deposition coating bath, and part of the terminal plate 1 (electrode-connection part) was connected to a negative terminal of a direct-current power supply apparatus, with a carbon (opposing) counter-electrode immersed in the water bath being connected to the positive terminal thereof, and a voltage of 20 to 220 V was applied for approximately 2 minutes, to perform electro-deposition coating. After that, the terminal plate 1 was removed from the electro-deposition tank and rinsed, and then pre-dried (for approximately 10 minutes at 80 to 100° C.) after air blowing. The masking material was removed from the pre-dried terminal plate 1, and subsequently the terminal plate 1 was moved to a heating apparatus, where the polyimide electro-deposition coating was baked (for 30 minutes at approximately 210° C.). A polyimide film 15 was formed in this way on the opposing surface 11 of the terminal plate and part of the four peripheral side surfaces 13 connecting to the four peripheral sides of the opposing surface 11 (see FIG. 3).

The film thickness t2 was measured at 18 locations of the polyimide film 15 that was formed on the opposing surface 11 of the terminal plate 1 (except for locations on the curved surfaces 14). The average film thickness of the polyimide film 15, as well as the standard deviation and coefficient of variance were calculated from the 18 values of film thickness, and the each calculated value was 23.62 μm for the average film thickness, 0.50 μm for the standard deviation, and 0.021 for the coefficient of variance.

Next, this terminal plate with polyimide film (intermediate product) was again rinsed in ion-exchanged water or purified water, and multi-staged plating was performed. Specifically, by performing chemical plating (non-electrolytic plating) in the order of zinc substitution plating, copper plating, nickel plating and gold plating, a conductive layer 16 having four layers of a zinc plating layer, copper plating layer, nickel plating layer and gold plating layer was formed on the exposed surface of the aluminum-alloy plate member. For example, by immersing the plate, for which plating was performed up to the nickel plating layer, into a gold cyanide bath, the gold plating layer was formed. During this step, the polyimide film 15 functioned as a masking material under the plating step, and the conductive layer 16 was formed on the entirety of the exposed surfaces of the aluminum alloy where the polyimide film 15 was not formed (in other words, the opposite surface 12 of the terminal plate and the remaining portions of the four peripheral side surfaces 13 connecting to the four sides of the opposite surface 12). The film thicknesses of the zinc plating layer, copper plating layer and nickel plating layer of the conductive layer 16 were 1 μm or less, respectively, while the film thickness of the gold plating layer, which is the outermost layer of the conductive layer 16, was 4 to 10 μm.

As shown in FIG. 3, an aluminum-alloy terminal plate 1 was obtained by forming both a polyimide film 15 as an insulating resin layer on the opposing surface 11 and portions of the four peripheral side surfaces 13 connecting to the four sides of the opposing surface 11 of the terminal plate, and a conductive layer 16 (anti-corrosive conductive layer) including a metal plating layer having good resistance to corrosion and good conductance on the remaining surfaces of the plate.

A fuel-cell stack as shown in FIG. 1 was constructed with terminal plates 1 of which at least the opposing surfaces 11 were coated with a polyimide film 15, and found no problem in electrical insulation between the terminal plate 1 and end plate 3. Any abnormalities were not observed in the function of terminal plates 1 as electrode terminals.

### An Example of Modification

The examples of the present invention may be modified as described below.

While, in the above example of the end plate 3, the polyimide film 35 was not formed in the areas that were masked with masking material, the polyimide film 35 may be formed over the entire surface of the metal plate member consisting the end plate 3 without applying the masking.

### Another Example of Modification

While, in the above example of the terminal plate 1, a conductive layer 16 was formed on all of the remaining exposed surfaces other than the areas where the polyimide film 15 was formed, the conductive layer 16 may be formed on only limited portion(s) of the remaining exposed surface(s) other than the portion where the polyimide film 15 is formed.

It should be noted that other objects, features and aspects of the present invention will become apparent in the entire disclosure and that modifications from the disclosed embodiments may be done without departing the scope of the present invention claimed as appended herewith.

Also it should be noted that any combination of the disclosed and/or claimed elements, matters and/or items may fall under the modifications aforementioned.

What is claimed is:

1. A fuel-cell stack comprising;
a battery-cell group in which a plurality of battery cells and separators are arranged; and
terminal plates and end plates that are arranged on each end section of the battery-cell group; wherein
said end plate is formed as a metal plate having a surface opposing to said terminal plate, and an insulating resin layer that electrically insulates between the end plate and terminal plate is formed by an electro-deposition coating method on at least the opposing surface of the end plate.

2. The fuel-cell stack of claim 1 wherein curved surfaces are formed on edge portions, which are formed by the opposing surface of said end plate and non-parallel surface that intersect with the opposing surface, such that said curved surfaces smoothly connect the opposing surface with the non-parallel surfaces, and said insulating resin layer continuously covers over the opposing surface, curved surfaces and non-parallel surfaces of the end plate.

3. A fuel-cell stack comprising;
a battery-cell group in which a plurality of battery cells and separators are arranged; and
terminal plates and end plates that are arranged on each end section of the battery-cell group; wherein
said terminal plate is formed as an electrically-conductive metal plate having a surface opposing to said end plate, and an insulating resin layer that electrically insulates between the terminal plate and end plate is formed by an electro-deposition coating method on at least the opposing surface of the terminal plate.

4. The fuel-cell stack of claim 3 wherein curved surfaces are formed on edge portions, which are formed by the opposing surface of said terminal plate and at least one non-parallel surface that intersects with said opposing surface, such that the curved surface smoothly connects the opposing surface with said at least one non-parallel surface, and said insulating resin layer continuously covers over the opposing surface, curved surface and said at least one non-parallel surface of the terminal plate.

5. The fuel-cell stack of claim 3 wherein an electrically conductive layer made from an electrically conductive metal is formed on portions of said terminal plate other than the portion coated with said insulating resin layer.

6. The fuel-cell stack of claim 1, wherein the standard deviation of the film thickness calculated from at least 10 arbitrary locations on said insulating resin layer, except said curved surface, formed on said opposing surface is 1 μm or less.

7. The fuel-cell stack of claim 3, wherein the standard deviation of the film thickness calculated from at least 10 arbitrary locations on said insulating resin layer, except said curved surface, formed on said opposing surface is 1 μm or less.

8. The fuel-cell stack of claim 1, wherein the average value of the film thickness calculated from at least 10 arbitrary locations on said insulating resin layer, except said curved surfaces, formed on said opposing surface is 10 μm to 40 μm.

9. The fuel-cell stack of claim 3, wherein the average value of the film thickness calculated from at least 10 arbitrary locations on said insulating resin layer, except said curved surfaces, formed on said opposing surface is 10 μm to 40 μm.

10. The fuel-cell stack of claim 1, wherein said insulating resin layer comprises a polyimide film formed by electro-deposition coating of a polyimide electro-deposition coating material.

11. The fuel-cell stack of claim 3, wherein said insulating resin layer comprises a polyimide film formed by electro-deposition coating of a polyimide electro-deposition coating material.

12. The fuel-cell stack of claim 1, wherein said insulating resin layer comprises a film of at least one resin selected from the group consisting of polyimide, fluororesin, polyamide-imide, epoxy resin, acrylic resin and a copolymer thereof.

13. The fuel-cell stack of claim 3, wherein said insulating resin layer comprises a film of at least one resin selected from the group consisting of polyimide, fluororesin, polyamide-imide, epoxy resin, acrylic resin and a copolymer thereof.

14. A method for manufacturing a terminal plate for a fuel-cell stack on which an insulating resin layer and a conductive layer are formed on its surface comprising the steps of:
a preparation step of preparing an electrically conductive metal plate member having a surface opposing to an end plate;
an electro-deposition coating step of forming an insulating resin film on at least said opposing surface of the entire surface of said electrically conductive metal plate member by an electro-deposition coating method using an electro-deposition coating material of an insulating resin; and
a plating step of coating the portions that are not coated by said insulating resin film with a conductive layer made from an electrically conductive metal by plating using said insulating resin film as a masking material during plating.

15. The method of manufacturing a terminal plate for a fuel-cell stack of claim 14 further comprising;
a rounding step of forming curved surfaces on the edge portions, which are formed by the opposing surface of said electrically conductive metal plate member and non-parallel surface that intersects with the opposing surface, so as to smoothly connect the opposing surface and the non-parallel surface after said preparation step; wherein
in said electro-deposition coating step, said insulating resin film is continuously formed over the opposing surface, curved surfaces and non-parallel surfaces of said electrically conductive metal plate member by an electro-deposition coating method using an electro-deposition coating material of insulating resin.

16. The method for manufacturing a terminal plate for a fuel-cell stack of claim 14, wherein the electrically conductive layer formed by said plating step includes an anti-corrosive electrically conductive layer made from an anti-corrosive electrically conductive metal superior in resistance to corrosion to the electrically conductive metal of said plate member.

17. The method for manufacturing a terminal plate for a fuel-cell stack of claim 15, wherein the electrically conductive layer formed by said plating step includes an anti-corrosive electrically conductive layer made from an anti-corrosive electrically conductive metal superior in resistance to corrosion to the electrically conductive metal of said plate member.

18. The method for manufacturing a terminal plate for a fuel-cell stack of claim 14 further comprising a fixation step of performing heat fixation of said insulating resin film on said opposing surface after said electro-deposition coating step.

19. The method for manufacturing a terminal plate for a fuel-cell stack of claim 14, wherein said insulating resin film comprises a polyimide film.

20. The method for manufacturing a terminal plate for a fuel-cell stack of claim 14, wherein said insulating resin film comprises at least one selected from the group consisting of polyimide, fluororesin, polyamide-imide, epoxy resin, acrylic resin and a copolymer thereof.
